(19) United States
(12) Patent Application Publication
(10) Pub. No.: US 2018/0022968 A1
(43) Pub. Date: Jan. 25, 2018

(54) ANISOTROPIC CONDUCTIVE FILM AND CONNECTION STRUCTURE

(71) Applicant: DEXERIALS CORPORATION, Shinagawa-ku, Tokyo (JP)

(72) Inventors: Shigeyuki YOSHIZAWA, Kanuma-shi (JP); Masao SAITO, Sano-shi (JP); Yasushi AKUTSU, Utsunomiya-shi (JP)

(73) Assignee: DEXERIALS CORPORATION, Shinagawa-ku, Tokyo (JP)

(21) Appl. No.: 15/546,150

(22) PCT Filed: Mar. 18, 2016
(86) PCT No.: PCT/JP2016/058753

§ 371 Date: Jul. 25, 2017

(30) Foreign Application Priority Data
Mar. 20, 2015 (JP) 2015-058386
Feb. 20, 2016 (JP) 2016-030518

(51) Int. Cl. C09J 9/02; H01B 5/16; H01R 43/00; H01B 13/00; H01R 11/01; C09J 7/00; H01B 1/22

(52) U.S. Cl. CPC C09J 9/02; C09J 7/00; H01B 5/16; H01B 1/22; H01B 13/0036; H01R 11/01; H01R 43/00

(57) ABSTRACT

Provided is an anisotropic conductive film that allows conductive particles to be sufficiently captured even by connecting terminals disposed at a fine pitch and can suppress a short circuit, and in particular, that can suppress variation of conduction resistance of a connection portion even when partial contact is caused by a thermal pressing tool during anisotropic conductive connection. In an anisotropic conductive film 1A, an insulating adhesive layer 3 contains conductive particles 2. The conductive particles 2 have an aspect ratio of 1.2 or more and are dispersed without being in contact with each other as viewed in a plan view, and an angle formed between a film surface S of the anisotropic conductive film 1A and a major axis direction of each of the conductive particles 2 is less than 40°. The anisotropic conductive film 1A preferably contains columnar conductive glass particles as the conductive particles 2.

### TECHNICAL FIELD

The present invention relates to an anisotropic conductive film and a connection structure connected using the anisotropic conductive film.

### BACKGROUND ART

An anisotropic conductive film has been widely used in connection of a glass substrate of a display panel such as a liquid crystal panel and an organic EL panel to a flexible printed circuit (FPC) substrate, mounting of an electronic component such as an IC chip on a substrate, or the like.

For example, as shown in FIG. 6, an FPC substrate 100 to be connected to a glass substrate of a display panel often has, on one side thereof, a bump group in which many elongated bumps 110 each having a width of 20 μm or more and 600 μm or less, a length of 1,000 μm or more and 3,000 μm or less, and a height of 0.1 μm or more and 500 μm or less are arranged at a pitch of several tens μm or more and several hundreds μm or less. When the bump group of such an FPC substrate is connected to the display panel, first, an anisotropic conductive film is temporarily bonded to the glass substrate. The FPC substrate is mounted on the anisotropic conductive film with a bump-forming surface side facing the anisotropic conductive film, and a wide thermal pressing tool having a flat pressing surface is adjusted so as to be parallel to the glass substrate. After that, a thermo-compression bonding treatment from the FPC substrate side is performed to achieve anisotropic conductive connection between the FPC substrate and the glass substrate.

However, even when a thermal pressing tool 115 is adjusted so as to be parallel to a glass substrate 120 as shown in FIG. 7A and an FPC substrate is thermo-compression bonded through an anisotropic conductive film 1X, repeated thermo-compression bonding breaks the parallel relation (see FIG. 7B), to cause partial contact of the thermal pressing tool 115. The conduction resistance value of an anisotropic conductive connection part on a side where no partial contact is caused (a side that is relatively weakly pressed) tends to be higher than that of the anisotropic conductive connection part on a side where partial contact is caused (a side that is strongly pressed). Therefore, there has been a problem in which the conduction resistance values of the anisotropic conductive connection parts on the former and later sides are largely varied depending on bumps. In recent years, due to an increase in size of a display panel, a width L of the bump group of the FPC substrate 100 (distance between one bump at an end of the bump group and one bump at another end thereof) reaches several meters, and as a result, the width of pressing surface of the thermal pressing tool is also significantly increased. Therefore, this problem is more prominent.

In order to solve this problem, adjustment of parallelism of the thermal pressing tool relative to the glass substrate every thermo-compression bonding treatment is considered. However, this causes a problem of significantly decreasing productivity. On the other hand, insulating spacers (Patent Literature 1) that have been conventionally used to achieve both conductivity in a thickness direction and insulation in a surface direction of the anisotropic conductive film and each have a spherical shape with a smaller diameter than those of conductive particles are expected to function as a gap spacer for relaxing partial contact of the thermal pressing tool and uniformly crushing the conductive particles.

When the anisotropic conductive film is used in mounting of an electronic component such as an IC chip, it has been desirable to improve the conductive particle capturing efficiency and connection reliability in a connection structure using the anisotropic conductive film and decrease the short circuit occurrence ratio in terms of mounting with high density. Therefore, it has been proposed that particle parts (i.e., conductive particle units) where a plurality of conductive particles are arranged in contact with or in close proximity to each other are disposed in a lattice form on an insulating adhesive layer of the anisotropic conductive film and an interval between the conductive particle units is varied depending on an electrode pattern (Patent Literature 2).

### CITATION LIST

### Patent Literature

Patent Literature 1: Japanese Patent Application Laid-Open No. 2006-335910

Patent Literature 2: Japanese Patent Application Laid-Open No. 2002-519473

### SUMMARY OF INVENTION

### Technical Problem

However, even when the spherical insulating spacers are contained in the anisotropic conductive film to achieve anisotropic conductive connection between the glass substrate and the FPC substrate, the spherical insulating spacers come into point contact with a wiring or a bump without contact over a wide area. Therefore, the pressing force of the thermal pressing tool cannot be sufficiently dispersed. For this reason, there is a problem in which the conduction resistance value of the anisotropic conductive connection part on the side where no partial contact is caused is increased, for example, to 4Ω or more.

The conductive particles and the insulating spacers are different in material and average particle diameter. Therefore, it is not easy that the conductive particles and the insulating spacers are uniformly dispersed in the anisotropic conductive film. Further, the conductive particles and the insulating spacers may be overlapped during anisotropic conductive connection to reduce the initial conduction characteristics.

On the other hand, the anisotropic conductive film described in Patent Literature 2 is used in mounting of an electronic component such as an IC chip on a substrate. In this case, the conductive particle unit is formed by filling a mold with a plurality of spherical conductive particles having high mobility. Therefore, the filling rate of the conductive particles in the mold and the positions of the conductive particles in the mold are unstable.

When the spherical conductive particles are disposed between facing terminals in anisotropic conductive connection, the conductive particles are first in point contact with surfaces of the terminals. Therefore, when the center of each of the conductive particles is not present within facing surfaces that face each other, the conductive particles are shifted from a space between the terminals. For this reason, there is also a problem in which the conductive particle capturing efficiency by the terminals is difficult to be increased.

Accordingly, the anisotropic conductive film described in Patent Literature 2 has a problem in terms of conduction reliability.

An object of the present invention is to provide an anisotropic conductive film that allows conductive particles to be sufficiently captured, and can suppress a short circuit and reduce variation of conduction resistance due to partial contact even when a fine-pitch IC chip is mounted with high density using the anisotropic conductive film or even when a glass substrate of a display panel that has an increased size is connected to an FPC substrate using the anisotropic conductive film.

### Solution to Problem

The present inventor has found that when conductive particles having an aspect ratio that is equal to or more than a specific value are used as conductive particles used in an anisotropic conductive film instead of a conductive particle unit that is formed by filling a mold with a plurality of spherical conductive particles, the capturing area of the conductive particles by connecting terminals can be increased, and therefore, variation of conduction resistance due to partial contact is reduced to improve the conduction reliability. Further, the present inventor has found that during arrangement of the conductive particles having the aspect ratio using a mold, the mobility of the conductive particles having the aspect ratio is lower than that of the spherical conductive particles, and therefore, the conductive particles can be disposed in a desired arrangement with high accuracy, to decrease the occurrence ratio of failure of disposition and improve the production efficiency of the anisotropic conductive film. The present invention has thus been completed.

Specifically, the present invention provides an anisotropic conductive film having an insulating adhesive layer containing conductive particles, wherein the conductive particles have an aspect ratio of 1.2 or more and are dispersed without being in contact with each other as viewed in a plan view, and an angle formed between a film surface of the anisotropic conductive film and a major axis direction of each of the conductive particles is less than 40°.

Further, the present invention provides a connection structure in which a connecting terminal of a first electronic component and a connecting terminal of a second electronic component are connected by anisotropic conductive connection using the anisotropic conductive film described above.

Moreover, the present invention provides a method for connecting the first electronic component to the second electronic component by anisotropic conductive connection using the anisotropic conductive film, the method including: temporarily bonding the anisotropic conductive film to the second electronic component; mounting the first electronic component on the anisotropic conductive film having been temporarily bonded; and thermo-compression bonding them from a side of the first electronic component.

### Advantageous Effects of Invention

According to the anisotropic conductive film of the present invention, conductive particles have an aspect ratio that is equal to or more than a specific value. Therefore, terminals are not brought into point contact with the conductive particles, but are brought into line contact with the conductive particles during anisotropic conductive connection. Accordingly, the contact area between the terminals and the conductive particles is increased to improve the conductive particle capturing properties by the terminals.

Due to the line contact, a pressing force is dispersed in the major axis directions of the conductive particles even when partial contact is caused by a thermo-compression bonding tool. Therefore, the conductive particles sufficiently function as gap spacers without damaging a bump and a wiring. Accordingly, even when partial contact is caused by the thermo-compression bonding tool, a favorable conduction resistance value can be achieved at both a side where partial contact is caused and a side where no partial contact is caused.

In particular, when the conductive particles are formed from columnar conductive glass particles, the degree of anisotropic conductive connection can be easily confirmed by visual observation of not only pushing of the particles but also the crushing state of the glass particles. For this reason, the whole cost for anisotropic conductive connection including an inspection cost can be decreased.

Assume a case where conductive particles having an aspect ratio that is equal to or more than a specific value are used in a process of producing the anisotropic conductive film when a mold is filled with the conductive particles to be arranged. In this case, excessive movement of the conductive particles can be suppressed as compared with spherical particles, and thus, the conductive particles are unlikely to be dropped off from the mold. The conductive particles can thus be precisely disposed in a desired arrangement.

According to the anisotropic conductive film of the present invention, the conductive particles are dispersed without being in contact with each other as viewed in a plan view. Therefore, occurrence of a short circuit at the terminals connected through anisotropic conductive connection can be reduced in spite of the conductive particles having an aspect ratio that is equal to or more than the specific value.

It is not necessary that insulating spacers be especially used. Therefore, it is easy to uniformly disperse the conductive particles in the anisotropic conductive film. In addition, the material cost is reduced. Further, the insulating spacers and the conductive particles are not overlapped in the anisotropic conductive film.

### BRIEF DESCRIPTION OF DRAWINGS

FIG. 1A is a plan view of conductive particles of an anisotropic conductive film 1A of an embodiment.

FIG. 1B is a cross-sectional view of the conductive particles of the anisotropic conductive film 1A of the embodiment.

FIG. 1C is a cross-sectional view of the conductive particles of the anisotropic conductive film 1A of the embodiment.

FIG. 2A is a plan view of conductive particles of an anisotropic conductive film 1B of an embodiment.

FIG. 2B is a cross-sectional view of the conductive particles of the anisotropic conductive film 1B of the embodiment.

FIG. 3A is a plan view of conductive particles of an anisotropic conductive film 1C of an embodiment.

FIG. 3B is a cross-sectional view of the conductive particles of the anisotropic conductive film 1C of the embodiment.

FIG. 4 is a transparent perspective view of an anisotropic conductive film 1D of an embodiment.

FIG. 5 is a transparent perspective view of an anisotropic conductive film 1E of an embodiment.

FIG. 6 is an enlarged view of a bump-forming surface of a flexible printed circuit substrate.

FIG. 7A is a cross-sectional view of a thermal pressing tool and a glass substrate that are adjusted so as to be parallel to each other when the anisotropic conductive connection is started.

FIG. 7B is a cross-sectional view of the thermal pressing tool and the glass substrate in which partial contact is caused during anisotropic conductive connection.

### DESCRIPTION OF EMBODIMENTS

Hereinafter, the present invention will be described in detail with reference to the drawings. In the drawings, the same reference signs denote the same or similar elements.

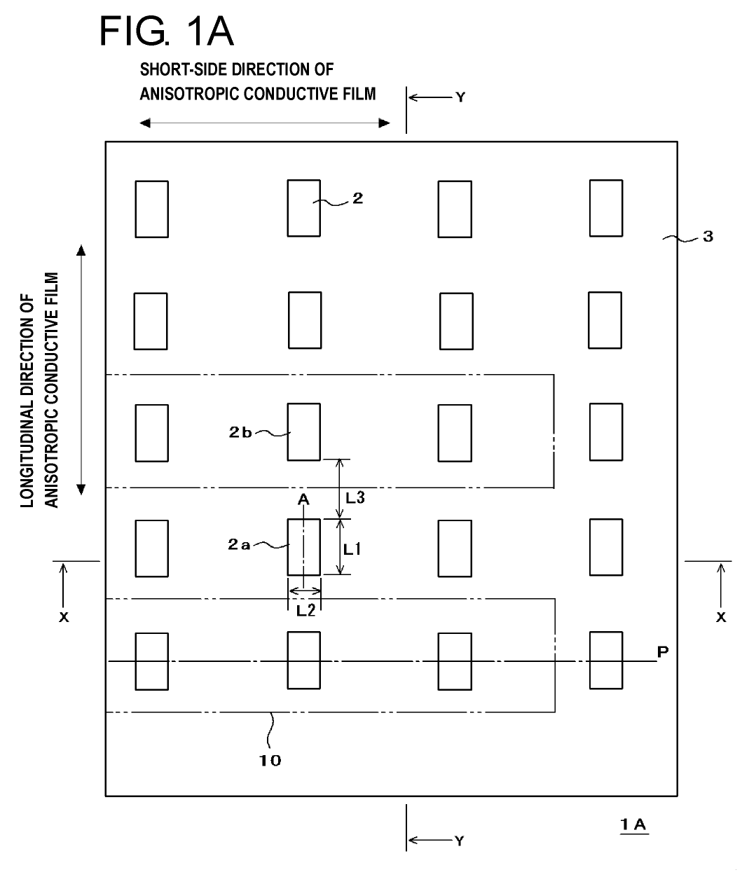

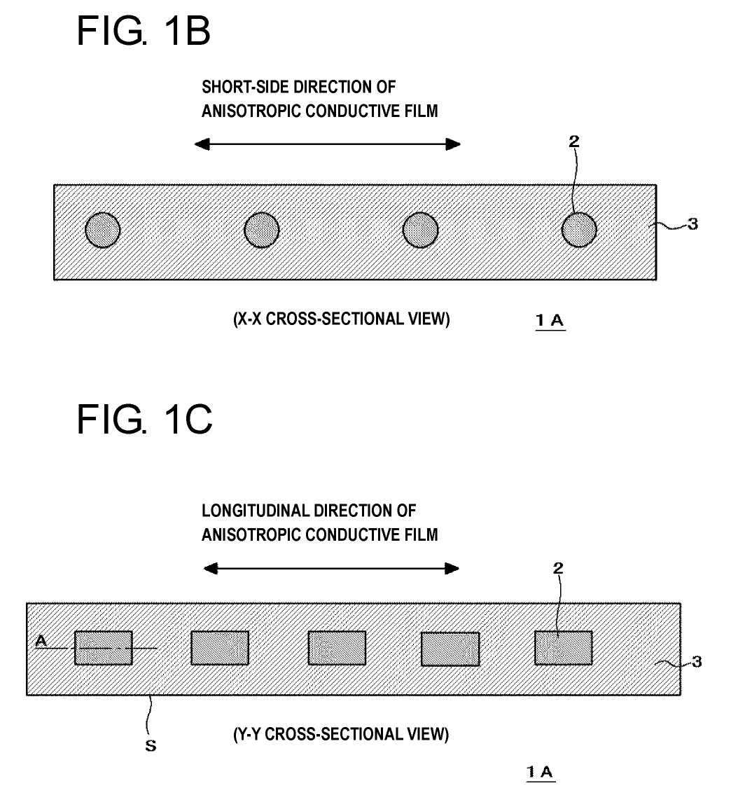

FIG. 1A is a plan view illustrating the disposition of conductive particles 2 in an anisotropic conductive film 1A of one embodiment of the present invention, and FIGS. 1B and 1C are each a cross-sectional view thereof. FIG. 2A is a plan view of an anisotropic conductive film 1B of one embodiment in which the disposition of conductive particles is different from that in the previous embodiment, and FIG. 2B is a cross-sectional view thereof. In the anisotropic conductive films 1A and 1B, the conductive particles 2 that have a cylindrical shape with an aspect ratio of 1.2 or more are used, and are dispersed in an insulating adhesive layer 3 without being in contact with each other as viewed in a plan view.

### <Material for Conductive Particles>

As the conductive particles 2, for example, columnar conductive glass particles having a conductive layer formed on at least a portion of a columnar glass surface, and preferably on the entire of the surface can be used. Examples of the conductive layer may include thin films of gold, silver, nickel, copper, ITO, and the like that are formed by procedures such as electroless plating and CVD. The thickness of the conductive layer is usually 5 nm or more, preferably 10 to 800 nm, and more preferably 100 to 500 nm. The degree of “at least a portion of the surface” is not particularly limited as long as anisotropic conductive connection is possible.

Use of such columnar conductive glass particles can relax a stress even when a pressing force is excessively applied to the conductive particles during anisotropic conductive connection. This relaxation is achieved by crushing the columnar conductive glass particles themselves. Therefore, when partial contact is caused by the thermal pressing tool, the conductive particles function as gap spacers, to prevent a bump and a wiring from being damaged. As a result, a favorable conduction resistance value can be achieved. Further, an inspection of confirming an impression of the bump after anisotropic conductive connection is facilitated. In addition, the columnar conductive glass particles are unlikely to be affected by expansion and contraction due to heat, and corrosion due to metal ions and migration of the metal ions do not occur. When an ultraviolet-curable insulating adhesive is used, insufficient curing is unlikely to occur. This is because ultraviolet light is transmitted to some extent.

As the conductive particles 2, conductive particles in which the conductive layer is formed on a resin core may be used. In a process of producing the resin core, an aggregate of the resin core may be obtained. In this case, from the aggregate of the resin core, the resin core having the aforementioned aspect ratio is separated, and is used. Specifically, depending on the process of producing the resin core, the aggregate (secondary particles) may be obtained in an intermediate step thereof. In this case, the aggregated resin core is disintegrated. In the disintegration, it is preferable that the aggregate of the resin core that is aggregated during drying of a solvent be disintegrated without deforming a particle shape. In this operation, a dispersant or a surface modifying agent may be added in advance during mixing so as to facilitate the disintegration, or a disintegration treatment in which the particle shape is hardly deformed may be performed. The disintegration treatment may be repeated, or classification may be performed before, during, or after the disintegration step. The disintegration can be performed using a stream-type crusher as one example. Specific examples thereof may include desktop-type LABORATORY JET MILL A-O JET MILL and CO-JET SYSTEM (all manufactured by Seishin Enterprise Co., Ltd.). A cyclone-type collecting mechanism may be combined. The preferable resin core is a resin core formed from a plastic material having excellent compression deformation. For example, the resin core can be formed from a (meth)acrylate-based resin, a polystyrene-based resin, a styrene-(meth)acrylic copolymer resin, a urethane-based resin, an epoxy-based resin, a phenol resin, an acrylonitrile-styrene (AS) resin, a benzoguanamine resin, a divinylbenzene-based resin, a styrene-based resin, a polyester resin, or the like. Since the resin core has excellent compression deformation, the connection state is easily evaluated from impressions of the particles that are formed at the terminals during anisotropic conductive connection. The conductive layer can be formed by a publicly known procedure such as electroless plating, as described above. The material for the conductive layer and the thickness thereof may be substantially the same as described above.

When the conductive particles each have a protrusion on a surface thereof, a resin core having a predetermined aspect ratio is separated from an aggregate of a resin core having a protrusion, and the conductive layer may be formed on the surface of the resin core. After separation of the resin core having the predetermined aspect ratio, protruded particles may be formed on the resin core.

In addition to the aforementioned conductive particles, the anisotropic conductive film of the present invention may contain conductive particles, which are used in a publicly known anisotropic conductive film, within a range in which the effects of the present invention are not impaired. Examples of such particles may include metal particles of nickel, cobalt, silver, copper, gold, and palladium, particles of alloy such as solder, and metal-coating resin particles.

### <Shape of Conductive Particles>

Aspect Ratio

In the anisotropic conductive film of the present invention, the aspect ratio (average major axis length/average minor axis length) of the conductive particles 2 is 1.2 or more, preferably 1.3 or more, and more preferably 3 or more, and is preferably 15 or less, more preferably 10 or less, and further preferably 5 or less. When the aspect ratio is too small, the conductive particle capturing properties by the terminals during anisotropic conductive connection cannot be improved. In contrast, when the aspect ratio is too large, short circuit is easy to occur depending on the distance of a space between the terminals. Depending on the material for the conductive particles 2, handleability is difficult. This causes an increase in production cost of the anisotropic conductive film.

In particular, when the conductive particles are the columnar conductive glass particles, the aspect ratio is preferably 1.33 or more and 20 or less, and more preferably 1.67 or more and 6.67 or less in terms of favorably dispersing the pressing force of the thermal pressing tool. When the aspect ratio falls within this range, the pressing force of the thermal pressing tool can be favorably dispersed, and handleability is favorable.

Herein, the aspect ratio represents a ratio of the average major axis length and average minor axis length of the conductive particles 2. When the conductive particles 2 have a columnar shape such as a cylindrical shape or a prismatic shape, a major axis length L1 is the length in a height direction (i.e., longitudinal direction) of each of the conductive particles 2, and can be measured as the longest length using an image-observing particle size distribution measuring device. The average major axis length is calculated by averaging the longest lengths of any 50 conductive particles. A minor axis length L2 is the longest length of diameters of transverse cross sections of each of the conductive particles 2, and can be measured using a metallographical microscope or a scanning electron microscope (SEM). The average minor axis length is calculated by averaging the minor axis lengths of any 50 conductive particles. The minor axis lengths can also be measured using a metallographical microscope or a scanning electron microscope (SEM). When the conductive particles are contained in the film, the major axis length and the minor axis length can be determined by observation as viewed in a plan view and observation of a cross section. When only the conductive particles are used as a sample for measurement separately from the insulating adhesive layer, the conductive particles are disposed on a flat surface so as to be prevented from aggregating, and observed as viewed in a plan view, whereby the average major axis length can be determined. In this case, the average minor axis length is in the depth direction of the measured sample. Therefore, the average minor axis length can be determined by adjustment of focal length of a scanning electron microscope (SEM).

A longitudinal cross-sectional shape of the columnar conductive particles is not limited to a rectangle. The shape of the columnar conductive particles includes a shape in which a side is expanded in the short-side direction, and a shape in which top and bottom end surfaces are expanded in the longitudinal direction. In these cases, the aspect ratio can be determined by the aforementioned procedure, and the average major axis length, average minor axis length, and aspect ratio in the film can be determined similarly. The measurement can be performed using a laser scanning-type three-dimensional shape measurement system KS-1100 (manufactured by Keyence Corporation).

When the aspect ratio of the conductive particles 2 in the anisotropic conductive film of the present invention falls within the range, the contact area between the terminals and the conductive particles 2 is increased, and the properties of capturing the conductive particles 2 by the terminals are improved. When the aspect ratio is too large, linkage of the conductive particles 2 is likely to occur during anisotropic conductive connection, and the short circuit occurrence ratio is increased. In contrast, when the aspect ratio is too small, the conductive particle capturing ratio by the terminals is decreased, and the conduction resistance is likely to be increased.

When the aspect ratio of the conductive particles 2 falls within the range, excessive movement of the conductive particles 2 is suppressed during filling of the mold with the conductive particles 2 in the process of producing the anisotropic conductive film. Therefore, the conductive particles 2 are difficult to be dropped off from the mold, and the conductive particles 2 can be precisely disposed in a desired arrangement. It is preferable that all the conductive particles 2 have substantially the same aspect ratio. Specifically, with respect to the distribution of the ratio of the major axis length to the minor axis length of the conductive particles, it is preferable that 90% or more of all the conductive particles be present within a range of ±20% of the aspect ratio, which is the ratio of the average major axis length to the average minor axis length of the conductive particles. It is more preferable that 95% or more of all the conductive particles be present within a range of ±20% of the aspect ratio. It is further preferable that 95% or more of all the conductive particles be present within a range of ±10% of the aspect ratio. When the ratios of the major axis length to the minor axis length of the respective conductive particles are set to be substantially the same value, capturing efficiency can be improved and the short circuit can be suppressed for, particularly, fine-pitch bumps.

Average Major Axis Length

The average major axis length of the conductive particles 2 is preferably 4 μm or more and 60 μm or less, and more preferably 6 μm or more and 20 μm or less. When the average major axis length is the length falling within the range, handleability is favorable, and the pressing force of the thermal pressing tool during anisotropic conductive connection can be favorably dispersed. Therefore, even when an area where the pressing force is relatively strong and an area where the pressing force is relatively weak are generated due to occurrence of partial contact, in which the pressure-bonding surface of the thermal pressing tool inclines with respect to a surface of a substrate to be connected, an increase in conduction resistance can be suppressed. The average minor axis length is preferably 1 μm or more, and more preferably 2.5 μm or more to prevent partial contact when the conductive particles are captured between the terminals. The average minor axis is further preferably 3 μm or more for the conductive particles to be firmly held between the terminals which each have an irregular surface, but not a planar surface.

Cross-Sectional Shape

It is desirable that the shape of the conductive particles 2 be a shape that has the aforementioned aspect ratio and in which a transverse cross-sectional shape is a shape having a contour formed by a curve, such as a circle or an ellipse. In this case, the pressing force of the thermal pressing tool during anisotropic conductive connection can be favorably dispersed. Therefore, even when partial contact is caused, an increase in conduction resistance can be suppressed.

A contour of the longitudinal cross-sectional shape in the short-side direction and a contour thereof in the longitudinal direction may each be formed from a straight line or a curve. When the contours of the longitudinal cross-sectional shape in the short-side direction and the longitudinal direction are each formed from a straight line (i.e., when the longitudinal cross-sectional shape is a rectangle), the conductive particles 2 have a columnar shape such as a cylindrical shape or a prismatic shape. When a face substantially parallel to the short-side direction of the longitudinal cross-sectional shape is semicircular or a face substantially parallel to the longitudinal direction is arc, the conductive particles have a so-called capsule-shaped columnar shape. In terms of dispersing the pressing force of the thermal pressing tool, a cylinder, an elliptic cylinder, and the like, in which the transverse cross section has a shape formed by a curve, such as a circle and an ellipse, are preferable. The shape may be a shape formed by lumping a plurality of spheres. In this case, the shape is a protruded shape as viewed in the longitudinal direction from a side. This makes it possible to accurately evaluate the connection state by the impressions of the conductive particles at the terminals. In terms of improving the particle capturing properties by the terminals, the shape may be a polygonal prism such as a hexagonal prism, a pentagonal prism, a quadrangular prism, and a triangular prism, a pentagrammic prism, and a hexagrammic prism. Among them, a cylinder is preferable. This is because the thermo-compression bonding conditions are easily set when the conductive particles are disposed in parallel to the bumps and brought into line contact with the bumps.

Surface Shape

On a surface of the conductive particles, a protrusion may be formed. For example, conductive particles described in Japanese Patent Application Laid-Open No. 2015-8129 or the like can be used. When such a protrusion is formed, a protective film provided to the terminals may be pierced during anisotropic conductive connection. It is preferable that the protrusion be formed so that the protrusion be evenly present on the surface of the conductive particles. In a process of filling the mold with the conductive particles to arrange the conductive particles in the process of producing the anisotropic conductive film, however, the protrusion may be partially lacked. The height of the protrusion may be, for example, 10 to 500 nm, or 10% or less of the minor axis length of the particles.

### <Arrangement of Conductive Particles>

In the anisotropic conductive film of the present invention, it is preferable that the conductive particles 2 be dispersed without being in contact with each other as viewed in a plan view, and a distance L3 between an optional conductive particle 2a and a conductive particle 2b closest to the conductive particle 2a as viewed in a plan view (i.e., the closest distance as viewed in a plan view) be 0.5 or more times the minor axis length L2 of the conductive particle 2a (FIGS. 1A and 2A) or the optional conductive particle 2a and the conductive particle 2b closest to the conductive particle 2a be not overlapped in the longitudinal direction of the anisotropic conductive film (FIG. 2A). In this case, it is possible to hardly cause a short circuit at the terminals connected through anisotropic conductive connection.

In the anisotropic conductive film of the present invention, the major axis directions A of the respective conductive particles 2 may be set in substantially the same direction or in different directions with regularity. For example, suppose the case where the major axis directions A of the conductive particles 2 are set in parallel to the longitudinal direction of the anisotropic conductive film 1A like the anisotropic conductive film 1A shown in FIG. 1A. In this case, when the aspect ratio of the conductive particles is 1.2 or more, the conductive particles are easily captured by the terminals even if alignment shift in the longitudinal direction of the film occurs during anisotropic conductive connection.

In contrast, when the major axis directions A of the conductive particles 2 are set in the short-side direction of the anisotropic conductive film, a short circuit is unlikely to occur even at a high number density of the conductive particles during anisotropic conductive connection. Therefore, when the number density of the conductive particles is increased, the conductive particles are easily captured by the terminals even if alignment shift occurs.

It is preferable that the major axis directions A of the conductive particles 2 be set in a direction oblique to the longitudinal direction of the film, like the anisotropic conductive film 1B shown in FIG. 2A. This is because the bumps to be connected through anisotropic conductive connection are generally extended in a direction orthogonal to the longitudinal direction of the film.

When the major axis directions A of the conductive particles 2 are set in substantially the same direction as described above, a product is easily judged to be acceptable or rejected in a product inspection.

On the other hand, the major axis directions A of the respective conductive particles 2 may be different directions with regularity. In this case, the respective effects of anisotropic conductive films in which the major axis directions of the conductive particles 2 are set differently from each other (for example, an effect of the anisotropic conductive film 1A and an effect of the anisotropic conductive film 1B) can be achieved at the same time. For this reason, an effect of reducing the number of the conductive particles can be further expected. Regularity to be imparted to the arrangement of the major axis directions A of the conductive particles 2 may be appropriately selected depending on layouts such as the dimension of the bumps as a connection subject and the distance between the bumps.

It is preferable that a procedure of disposing the conductive particles 2 in the aforementioned arrangement in the anisotropic conductive film be a procedure of spraying the conductive particles on a stretched film and then stretching the stretched film in an optional direction or a procedure of arranging the conductive particles using a mold, to be described later.

As an aspect of arrangement of the conductive particles 2 as viewed in a plan view, it is preferable that the centers of the conductive particles 2 be arranged with regularity in all directions. Specific examples of the aspect of arrangement with regularity may include aspects in which the centers of the conductive particles 2 are arranged in the form of a lattice such as a square lattice, a rectangular lattice, an orthorhombic lattice, a triangular lattice, and a hexagonal lattice. These aspects may be combined. When an interval of the lattice is appropriately set, the conductive particle captured properties can be improved while a short circuit during anisotropic conductive connection is suppressed.

In order to arrange the conductive particles with regularity, the following procedure is preferable. An arrangement axis P in which the centers of the conductive particles 2 are arranged in the film short-side direction is formed. Of the conductive particles on the arrangement axis P, a circumscribed line of an optional conductive particle in the film short-side direction be matched with a circumscribed line of a conductive particle adjacent to the optional conductive particle in the film short-side direction (FIG. 1A), or the circumscribed line of the optional conductive particle in the film short-side direction penetrates the conductive particle adjacent to the conductive particle. Thus, the conductive particle capturing properties by the terminals during anisotropic conductive connection can be improved.

When there is the arrangement axis P, in which the centers of the conductive particles 2 are arranged, in the minor axis directions of the conductive particles 2 (FIG. 1A) or the arrangement axis P, in which the centers of the conductive particles 2 are arranged, in the major axis directions of the conductive particles 2 (FIG. 2A), it is preferable that the adjacent conductive particles 2 in the arrangement axis P be overlapped in the short-side direction of the anisotropic conductive film. Thus, the conductive particle capturing properties by the terminals during anisotropic conductive connection can be improved.

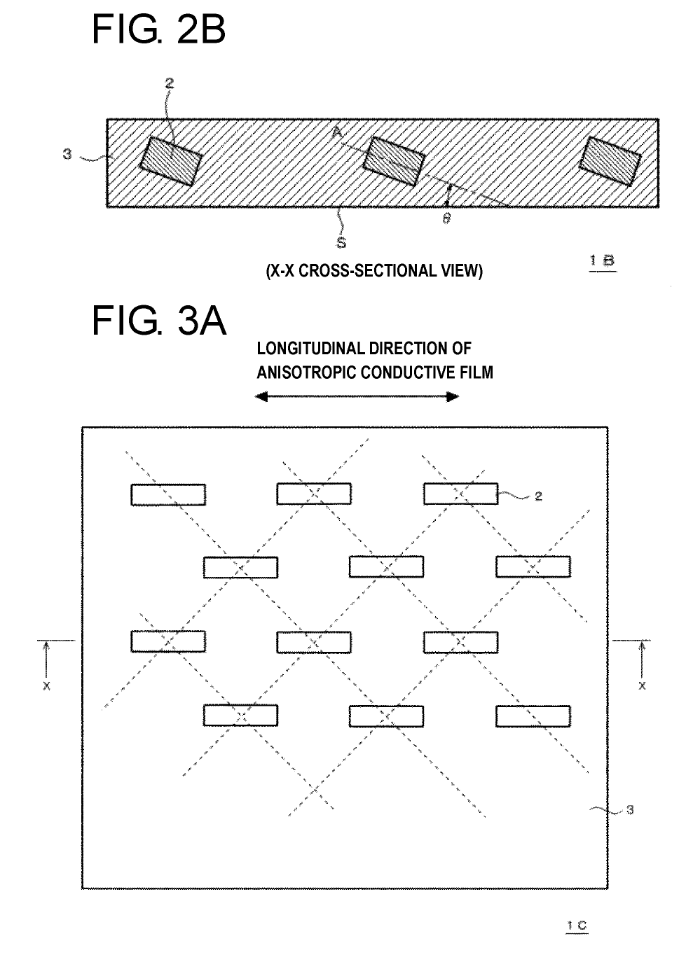

On the other hand, the conductive particles may be dispersed without regular arrangement, for example, depending on the applications of the anisotropic conductive film, the number density of the conductive particles in the anisotropic conductive film, or the like. For example, when the anisotropic conductive film is used in FOG connection, the conductive particles 2 can be irregularly dispersed, as shown in FIG. 4, at a number density of the conductive particles of 1 particle/mm² or more and 300 particles/mm² or less, more preferably 2 particles/mm² or more and 200 particles/mm² or less, and further preferably 3 particles/mm² or more and 50 particles/mm² or less. Even in this case, it is preferable that the conductive particles 2 be dispersed without being in contact with each other as viewed in a plan view.

As shown in FIG. 1C, an angle formed between a film surface S of the anisotropic conductive film and the major axis directions A of the conductive particles may be 0°, that is, the major axis directions A of the conductive particles 2 may be substantially parallel to the film surface S. As shown in FIG. 2B, the major axis directions A of the conductive particles 2 may be inclined relative to the film surface S. When the major axis directions A of the conductive particles 2 are inclined relative to the film surface S, the angle θ between the film surface S of the anisotropic conductive film and the major axis directions A of the conductive particles is less than 40°, and more preferably within 15°. Herein, the numerical value of the angle θ means to satisfy that the number percentage of conductive particles forming such an angle relative to the film surface is 80% or more, and more preferably 95% or more. This angle θ can be measured from an image taken as a film cross section of the anisotropic conductive film using an optical microscope or an electron microscope. When the angle θ is less than 40°, the major axis directions A of the conductive particles 2 can be made substantially parallel to the surfaces of the terminals by thermo-compression bonding during anisotropic conductive connection. Further, shift of the conductive particles during capturing can be minimized. Specifically, partial contact caused by breaking parallelism of the pressing surface of the thermal pressing tool to a surface to be pressed during anisotropic conductive connection can be suppressed.

In a case of a rigid substrate which is one of electronic components to be connected through the anisotropic conductive film, it is necessary to fill a space between the electronic components with a comparatively large amount of a resin during connection, and the thickness of an insulating adhesive layer in the anisotropic conductive film is increased. In this case, the angle θ can be increased depending on the thickness of the layer. This is because, even when the angle θ of the conductive particles in the insulating adhesive layer is large, the angle θ of the major axis directions of the conductive particles contained in the insulating adhesive layer relative to the film surface is decreased due to crushing of the insulating adhesive layer by heating and pressurization during anisotropic conductive connection. Even when the lengths of the conductive particles in the major axis direction are short, the angle θ of the conductive particles in the insulating adhesive layer before anisotropic conductive connection can be increased because of the same reason as described above. Therefore, for example, when the thickness of the insulating adhesive layer is 3 to 50 μm and the angle θ is within 70°, the major axis direction of each of the conductive particles may be made substantially parallel to the film surface during thermo-compression bonding.

### <Density of Conductive Particles>

In the anisotropic conductive film of the present invention, the number density of the conductive particles 2 can be adjusted within a range that is appropriate to secure conduction reliability depending on the width of the terminals or the pitch between the terminals as connection subjects. When three or more, and preferably 10 or more conductive particles are captured by a pair of facing terminals, favorable conduction characteristics are usually obtained. In a case of FOG connection in which a space between the terminals has a distance of 50 to 200 μm, the density may be preferably 1 particles/mm² or more and 300 particles/mm² or less, more preferably 2 particles/mm² or more and 200 particles/mm² or less, and further preferably 3 particles/mm² or more and 50 particles/mm² or less in practical terms. In this case, a preferable amount of the conductive particles (preferably columnar conductive glass particles) present in the anisotropic conductive film is preferably 1 part by mass or more and 25 parts by mass or less, and more preferably 5 parts by mass or more and 15 parts by mass or less relative to the whole amount of the anisotropic conductive film that is 100 parts by mass.

Regardless of the connection subjects, the terminals having a large width (as an example, about 100 to 200 μm) can be sufficiently connected at a density of 100 particles/mm² or more, preferably 500 particles/mm² or more, and more preferably 1,000 particles/mm² or more. When the pitch between the terminals is fine pitch (as an example, the terminal width and the space between the terminals are each 30 μm or less), the density is preferably 50,000 particles/mm² or less, and more preferably 30,000 particles/mm² or less in order to prevent a short circuit without generation of terminals that do not capture the conductive particles.

### <Method of Fixing Conductive Particles>

In a method of fixing the conductive particles 2 in a predetermined arrangement in the insulating adhesive layer 3, a mold having hollows arranged in a manner corresponding to the arrangement of the conductive particles 2 is produced by a publicly known method such as machining, laser processing, or photolithography, the conductive particles 2 may be put into the mold, the mold may be filled with a composition for forming an insulating adhesive layer over the conductive particles 2, and the product may be taken from the mold, whereby the conductive particles 2 may be transferred to the insulating adhesive layer 3. Using such a mold, a mold may further be produced from a material having low rigidity.

In order to dispose the conductive particle 2 in the insulating adhesive layer 3 in the aforementioned arrangement, a method may be used in which a member having penetrating holes in a predetermined disposition is provided on a layer of the composition for forming an insulating adhesive layer, and the conductive particles 2 are supplied over the member and allowed to pass through the penetrating holes.

### <Layer Configuration>

The anisotropic conductive film of the present invention can have various layer configurations. For example, the conductive particles 2 are disposed on the insulating adhesive layer 3 of a single layer, and pushed into the insulating adhesive layer 3, whereby the conductive particles 2 may present at a certain depth from an interface of the insulating adhesive layer 3, like the anisotropic conductive film 1A described above.

Like an anisotropic conductive film 1D shown in FIG. 4, the columnar conductive glass particles having an aspect ratio of 1.2 or more may be dispersed as the conductive particles 2 in an insulating adhesive, followed by forming a film.

When the anisotropic conductive film 1D is produced by applying the insulating adhesive containing the conductive particles 2 dispersed therein, the thickness of the anisotropic conductive film 1D is preferably 3 μm or more and 50 μm or less, and more preferably 5 μm or more and 20 μm or less. This is because the major axes of the conductive particles 2 are oriented substantially in parallel to the film surface of the anisotropic conductive film so that the conductive particles 2 function as a good gap spacer. When the thickness falls within this range, it is easy to orient the major axis directions of the conductive particles substantially in parallel to the film surface.

In the present invention, the conductive particles are disposed on the insulating adhesive layer of a single layer, and then another insulating adhesive layer may be laminated to form an insulating adhesive layer having a two-layer configuration, or the lamination may be repeated to form a configuration of three layers or more. The second and subsequent insulating adhesive layers are formed to improve tackiness and control flow of the resin and the conductive particles during anisotropic conductive connection.

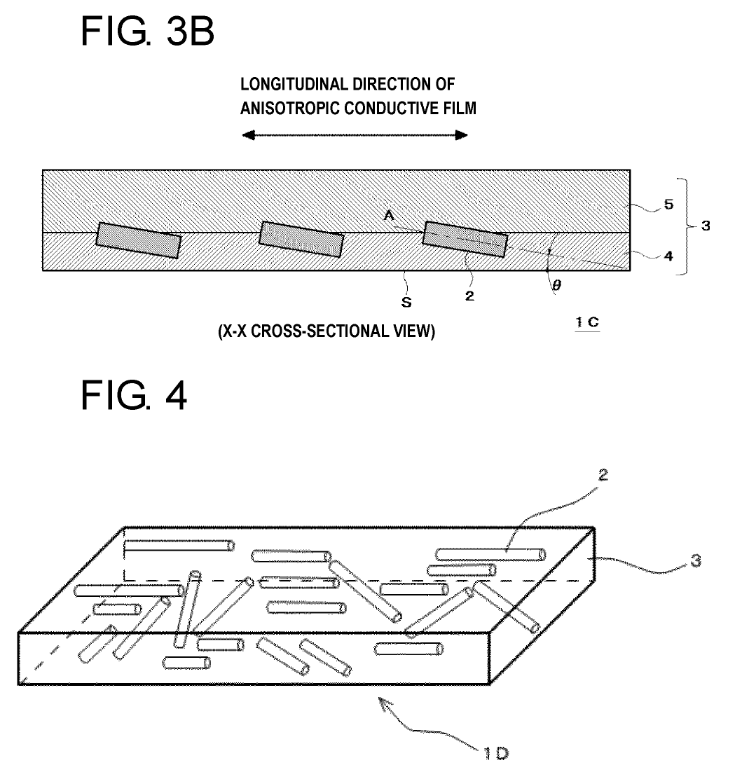

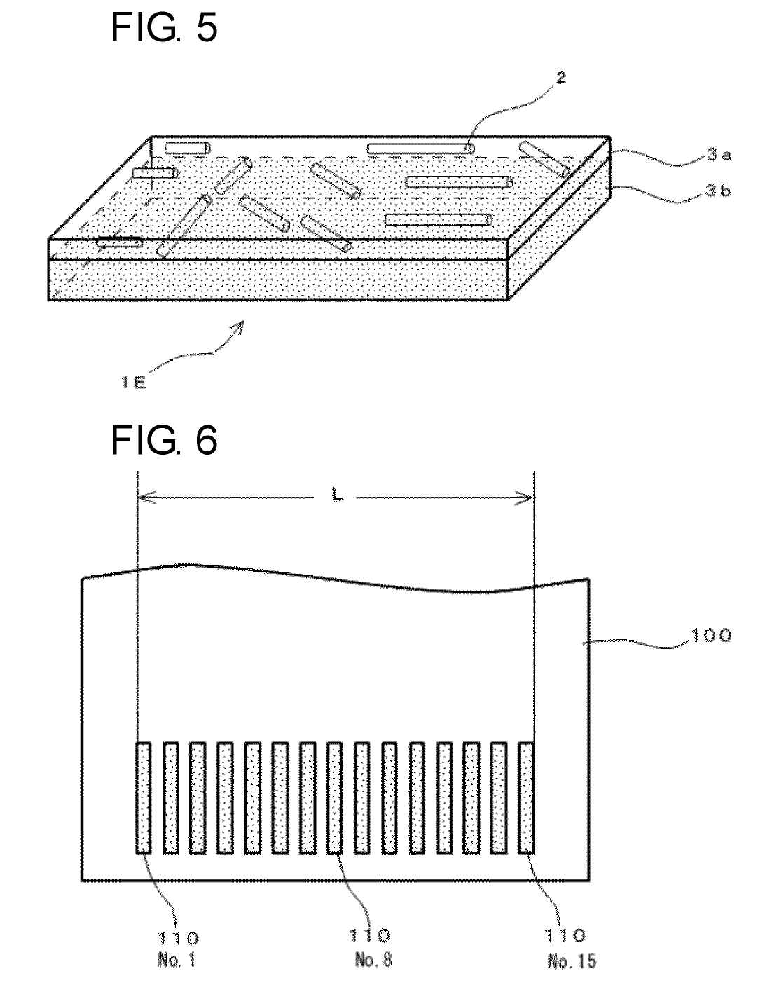

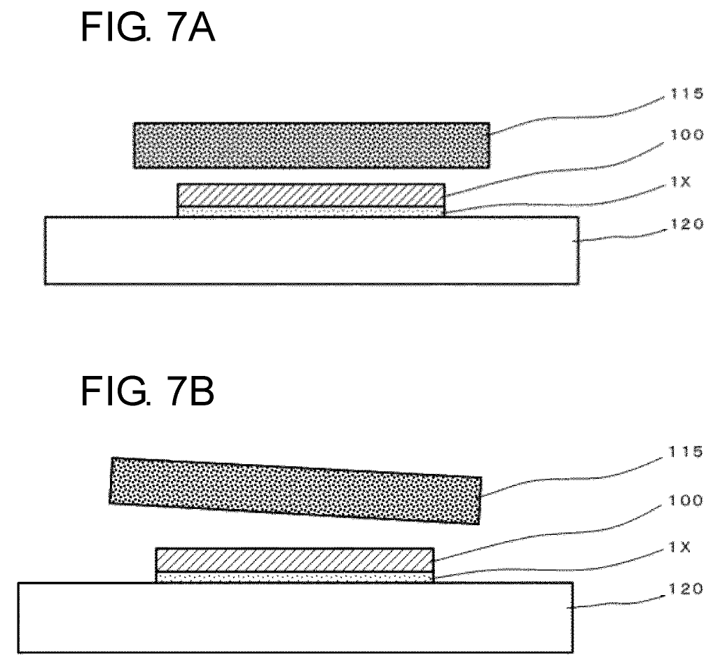

Like an anisotropic conductive film 1E shown in FIG. 5, a two-layer structure having a first adhesion layer 3a having the insulating adhesive layer containing the conductive particles 2 and a second adhesion layer 3b having the insulating adhesive layer containing no conductive particles can be formed. The first adhesion layer 3a can be formed similarly to the anisotropic conductive film 1D shown in FIG. 4, and the second adhesion layer 3b can be formed by forming the insulating adhesive layer. More specifically, another component such as a solvent is mixed in a photocurable insulating adhesive, if necessary, and the mixture is applied to a release film, and cured by light, to form the second adhesion layer 3b. Subsequently, the columnar conductive glass particles, and if necessary, another component such as a solvent, are mixed in the insulating adhesive, and the mixture is applied to the second adhesion layer 3b, and dried to form the first adhesion layer 3a. Alternatively, the first adhesion layer 3a and the second adhesion layer 3b that have been separately formed are laminated to produce the anisotropic conductive film 1E having a two-layer structure. A resin for an insulating adhesive layer forming the first adhesion layer 3a and the second adhesion layer 3b may be the same as the resin for the insulating adhesive layer forming the anisotropic conductive film 1D of a single layer shown in FIG. 4.

The thickness of the first adhesion layer 3a in the anisotropic conductive film having a two-layer structure is preferably 1 μm or more and 15 μm or less, and more preferably 2 μm or more and 10 μm or less. When the thickness thereof falls within this range, the major axis directions of the conductive particles 2 can be set within a predetermined angle relative to the film surface in an application process, and the productivity is thus improved.

The thickness of the second adhesion layer 3b in the anisotropic conductive film 1E is preferably 1 μm or more and 50 μm or less, and more preferably 3 μm or more and 20 μm or less. When the thickness falls within this range, a decrease in conductive particle capturing efficiency can be suppressed and an excessive increase in conduction resistance can be suppressed.

According to the anisotropic conductive film 1E, the conductive particles 2 can be disposed substantially in parallel to the film surface of the anisotropic conductive film at a high level as compared with the anisotropic conductive film 1D shown in FIG. 4. This is because the first adhesion layer 3a can be formed so as to be thin by a coating method.

The second adhesion layer 3b may contain an insulating spacer. Herein, the insulating spacer usually has a particle diameter that is slightly larger than the diameter of the conductive particles or equal to or less than the diameter of the conductive particles. From a state of the particle that is placed between the terminals with the conductive particles after connection, a function of the particle as the insulating spacer can be confirmed. Therefore, when the particle does not function as the insulating spacer, the particle is categorized as a filler such as an insulting filler. For the insulating spacer, a publicly known material having a size that is substantially equal to the minor axis length of each of the conductive particles can be used. When the insulating spacer is formed, for example, from a compressible resin such as a resin core, the particle diameter of the insulating spacer may be larger than the minor axis lengths of the conductive particles. When the insulating spacer is formed from a rigid material such as glass, the particle diameter of the insulating spacer is preferably equal to or less than the minor axis lengths of the conductive particles, and more preferably less than the minor axis lengths of the conductive particles. In this case, excessive pressing against each side of the conductive particles in the major axis direction can be suppressed.

For fixation of the conductive particles in the insulating adhesive layer, a photopolymerizable resin and a photopolymerization initiator may be mixed in the composition for forming an insulating adhesive layer and the mixture may be irradiated with light to fix the conductive particles. A reactive resin that does not contribute to anisotropic conductive connection may be used for fixation of the conductive particles and the aforementioned transfer. For example, a photocurable resin may be used to fix the conductive particles and a thermosetting resin may exert an adhesion function during anisotropic conductive connection. For example, an acrylic polymerizable resin can be used as the photocurable resin and an epoxy resin can be used as the thermosetting resin.

The lowest melt viscosity of the total thickness of the anisotropic conductive film 1A is preferably 100 to 10,000 Pa·s, more preferably 500 to 5,000 Pa·s, and particularly preferably 1,000 to 3,000 Pa·s. When the lowest melt viscosity falls within this range, the conductive particles can be precisely disposed in the insulating adhesive layer and any trouble in conductive particle capturing properties that is caused by resin flow due to pushing during anisotropic conductive connection can be prevented. The lowest melt viscosity can be measured using a rheometer (ARES, manufactured by TA Instruments) at a temperature increasing rate of 5° C./min under conditions of a measurement temperature range of 50 to 200° C. and an oscillation frequency of 1 Hz.

### <Insulating Adhesive Layer>

A material for the insulating adhesive layer 3 may be appropriately selected from insulating adhesives used in a publicly known anisotropic conductive film depending on application of the anisotropic conductive film, whereby the insulating adhesive layer 3 may be formed. Preferable examples of the insulating adhesive may include paste-like and film-like resins containing a polymerizable resin such as a (meth)acrylate compound and an epoxy compound and a thermal polymerization initiator or photopolymerization initiator. Herein, examples of the photopolymerization initiator may include a photo-radical polymerization initiator, a photo-cationic polymerization initiator, and a photo-anionic polymerization initiator. Examples of the thermal polymerization initiator may include a thermal radical polymerization initiator, a thermal cationic polymerization initiator, and a thermal anionic polymerization initiator. Specific examples of the insulating adhesive may include a photo-radical polymerizable resin containing an acrylate compound and a photo-radical polymerization initiator, a thermal radical polymerizable resin containing an acrylate compound and a thermal radical polymerization initiator, a thermal cationic polymerizable resin containing an epoxy compound and a thermal cationic polymerization initiator, a thermal anionic polymerizable resin containing an epoxy compound and a thermal anionic polymerization initiator, and a photo-cationic polymerizable resin containing an epoxy compound and a photo-cationic polymerization initiator.

These resins may be used in combination. The resins may be a resin obtained by polymerization of each of the resins, if necessary.

More specifically, for example, a thermosetting epoxy-based adhesive of the insulating adhesive layer may include a film-forming resin, a liquid epoxy resin (curing component), a curing agent, a silane-coupling agent, and the like.

Examples of the film-forming resin may include a phenoxy resin, an epoxy resin, an unsaturated polyester resin, a saturated polyester resin, a urethane resin, a butadiene resin, a polyimide resin, a polyamide resin, and a polyolefin resin. Two or more kinds thereof may be used in combination. Among them, a phenoxy resin may be preferably used in terms of film formation, processing, and connection reliability.

Examples of the liquid epoxy resin may include a bisphenol A-type epoxy resin, a bisphenol F-type epoxy resin, a novolac-type epoxy resin, and modified epoxy resins thereof, and an alicyclic epoxy resin. Two or more kinds thereof may be used in combination.

Examples of the curing agent may include latent curing agents including an anionic curing agent such as polyamine and imidazole, a cationic curing agent such as a sulfonium salt, and a phenolic curing agent.

Examples of the silane-coupling agent may include an epoxy-based silane-coupling agent and an acrylic silane-coupling agent. The silane coupling agents are mainly an alkoxysilane derivative.

In the thermosetting epoxy-based adhesive, a filler, a softener, a promoter, an age resistor, a colorant (pigment, dye), an organic solvent, an ion-catching agent, or the like may be mixed, if necessary.

To the insulating adhesive layer 3, an insulating filler such as silica fine particles, alumina, or aluminum hydroxide may be added, if necessary. The size of the insulating filler is such a size that a trouble is not caused in anisotropic conductive connection. It is usually preferable that the size of the insulating filler be made smaller than the average minor axis length of the conductive particles. The amount of the insulating filler added is preferably 3 to 40 parts by mass relative to 100 parts by mass of a resin forming the insulating adhesive layer. This can suppress the conductive particles 2 from unnecessarily shifting due to the molten resin even when the insulating adhesive layer 3 is molten during anisotropic conductive connection.

### <Film Thickness>

In order to sufficiently obtain adhesion strength, the thickness of the anisotropic conductive film (i.e., the thickness of the insulating adhesive layer 3) is preferably 3 μm or more and 50 μm or less, and more preferably 5 μm or more and 20 μm or less. When the thickness falls within this range, the anisotropic conductive film can be used without practical problems.

The ratio of the thickness of the insulating adhesive layer 3 (i.e., the thickness of the anisotropic conductive film) relative to the major axis length L1 of the conductive particles 2 taken as 100 is preferably 90 or less, and more preferably 25 or less, and the ratio of the thickness of the insulating adhesive layer 3 relative to the minor axis length L2 of the conductive particles 2 taken as 100 is preferably 100 or more, and more preferably 120 or more. This is because the major axis directions A of the conductive particles 2 are made substantially parallel to the film surface S of the anisotropic conductive film to make the major axis directions A of the conductive particles 2 substantially parallel to the terminal surface, improving the capturing state.

### <Connection Structure>

The anisotropic conductive film of the present invention can be preferably applied during anisotropic conductive connection by heat or light between the first electronic component such as an FPC, an IC chip, or an IC module and the second electronic component such as an FPC, a rigid substrate, a ceramic substrate, a glass substrate, or a plastic substrate. An IC chip and an IC module may be stacked to achieve anisotropic conductive connection between the first electronic components. Further, connection can also be achieved by photo-curing. The connection structure thus obtained is also a part of the present invention.

In a method of connecting the electronic components using the anisotropic conductive film, it is preferable that an interface of the anisotropic conductive film on a side close to the conductive particles in the film thickness direction be temporarily bonded to the second electronic component such as a wiring substrate, the first electronic component such as an IC chip be mounted on the anisotropic conductive film temporarily bonded, and the anisotropic conductive film be thermo-compression bonded from a side of the first electronic component in terms of enhancing the connection reliability. Further, connection can also be achieved by photo-curing. In terms of connection operation efficiency, it is preferable that the longitudinal direction of terminals 10 of the electronic components be set in the short-side direction of the anisotropic conductive films 1A and 1B, as shown in FIGS. 1A and 2A.

### EXAMPLES

Hereinafter, the present invention will be described specifically by Examples.

### Examples 1 to 3 and Comparative Examples 1 to 3

### (1) Production of Anisotropic Conductive Film

As conductive particles A, cylindrical conductive glass particles (Nippon Electric Glass Co., Ltd., PF-39SSSCA) (average major axis length: 14 μm, average minor axis length: 3.9 μm) plated with nickel (base) so as to have a thickness of 0.3 μm on a surface thereof and plated with gold (surface layer) so as to have a thickness of 0.1 μm on a surface of the base were prepared.

The conductive particles A were broken and classified to obtain cylindrical conductive glass particles B (average major axis length: 8 μm, average minor axis length: 3.9 μm) and cylindrical conductive glass particles C (average major axis length: 5.2 μm, average minor axis length: 3.9 μm) having sizes shown in Table 1. Spherical conductive glass particles D (Sekisui Chemical Co., Ltd., AUL704, particle diameter: 4 μm) were prepared.

Each resin composition having a composition shown in Table 2 was prepared, applied to a PET film with a thickness of 50 μm, and dried in an oven of 80° C. for 5 minutes, to form a first insulating resin layer with a thickness of 15 μm or 13 μm and a second insulating resin layer with a thickness of 3 μm or 5 μm on the PET film.

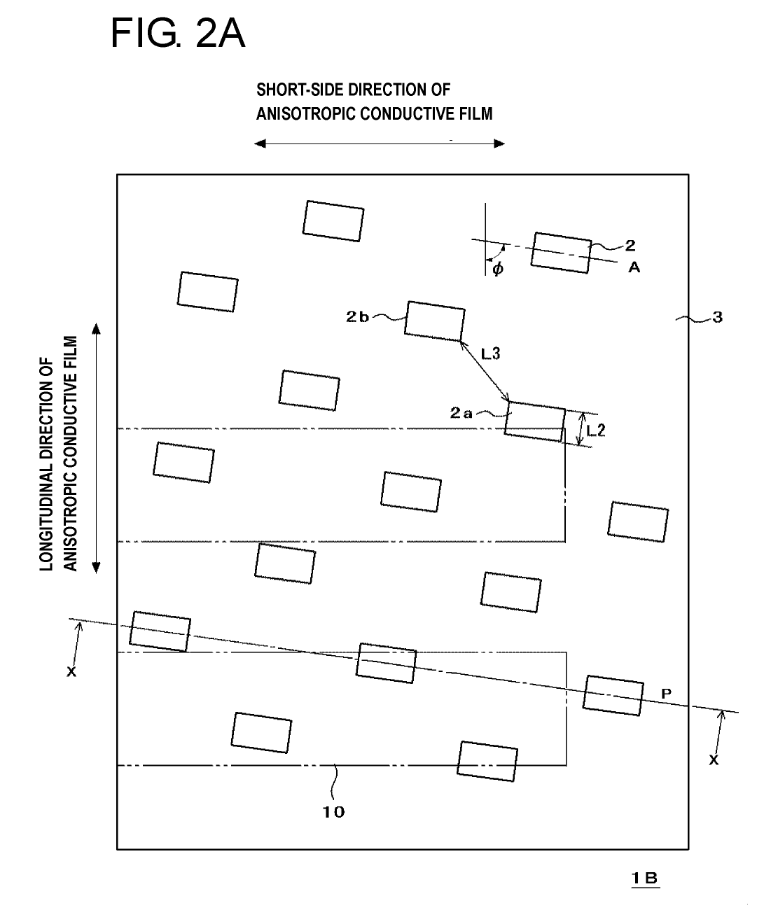

A metal mold having convex portions in a pattern corresponding to the following particle arrangements was prepared; as shown in FIG. 3A viewed in a plan view, the major axis directions of the conductive particles 2 were set in the longitudinal direction of the film, and the centers of the conductive particles 2 were arranged in a tetragonal lattice arrangement; and as shown in FIG. 3B in the cross section of the film, the conductive particles were arranged such that an angle (inclination angle θ) formed between the film surface S and each major axis direction A of the conductive particles 2 and a number density thereof were set as shown in Table 1. Pellets of a publicly known transparent resin were melted, poured into the metal mold, cooled, and solidified. A resin mold having concave portions in a pattern corresponding to the arrangement patterns shown in FIGS. 3A and 3B was thus formed (Examples 1 to 3 and Comparative Examples 1 and 3). In the dimension of the resin mold, the upper limit of an opening part was 1.3 times each of the average major axis length and the average minor axis length of the conductive particles in Examples 1 to 3. In Comparative Example 3, the size of the opening part as viewed in a plan view was made smaller than that in Example 1, and the height of the convex portions in the mold was made higher than that in Example 1. The closest distances between the convex portions in Examples 1 to 3 and Comparative Example 3 were 4 μm or more.

The concave portions in the resin mold was filled with the conductive particles of Table 1, and the second insulating resin layer 4 described above (3 μm) was placed over the conductive particles, pressed at 60° C. and 0.5 MPa, and bonded. The insulating resin was separated from the mold. The first insulating resin layer 5 (15 μm) was layered at 60° C. and 0.5 MPa on an interface of the second insulating resin layer 4 on a side of the conductive particles, to produce an anisotropic conductive film 1C of each of Examples 1 to 3 and Comparative Example 3.

An anisotropic conductive film of Comparative Example 1 was produced in the same manner as in Example 1 except that the shape of concave portions in the resin mold was changed. An anisotropic conductive film of Comparative Example 2 was produced by dispersing the conductive particles in the resin composition used for the second insulating resin layer without use of the resin mold, to form the second insulating resin layer with a dried thickness of 5 μm, and layering the first insulating resin layer with a thickness of 13 μm on the second insulating resin layer. An application gap of the second insulating resin layer was made smaller than the average major axis length of the conductive particles. Therefore, the major axis of the conductive particles was substantially parallel to the film surface during passing through the gap, and the inclination angle θ of the conductive particles was 15° or less.

The number density and the area occupancy ratio (area ratio of the conductive particles as viewed in a plan view of the anisotropic conductive film) in Table 1 were determined by observation of a plane of 200 μm×200 μm at five portions that had been optionally extracted from a part of the anisotropic conductive film used in anisotropic conductive connection.

Any cross section of the film and another cross section orthogonal to the cross section were observed (each cross section along the major axis and minor axis of the conductive particles was observed). The lengths of 200 successive conductive particles in the major axis direction and the minor axis direction were measured, and the aspect ratio was determined. From the cross sections, the inclination angle θ was calculated and determined. As a result, 90% or more of the total number of the cylindrical conductive glass particles A, B, and C and the spherical conductive glass particles D fell within ±20% of the aspect ratio determined from the average major axis length and the average minor axis length.

The thickness of the second insulating resin layer in Table 1 was a value measured by a film thickness meter (Litematic VL-50, manufactured by Mitutoyo Corporation).

### (2) Evaluation

For the anisotropic conductive films of Examples and Comparative Examples, (a) initial conduction characteristics, (b) short circuit occurrence ratio, and (c) conductive particle capturing efficiency were each evaluated as follows. The results are shown in Table 1.

### (a) Initial Conduction Characteristics

The anisotropic conductive film of each of Examples and Comparative Examples was placed between an IC for evaluation of initial conduction and conduction reliability and a glass substrate, and heated and pressurized (180° C., 20 MPa, 5 seconds) to obtain a connection product for each evaluation. In this case, the longitudinal direction of the anisotropic conductive film was matched with the short-side direction of bumps. The conduction resistance of the connection product for evaluation was measured. A conduction resistance of 5Ω or less was evaluated as OK, and a conduction resistance of more than 5Ω was evaluated as NG.

Herein, the IC for evaluation and the glass substrate corresponded to the pattern of terminals thereof, and the sizes were as follows.

### IC for Evaluation of Initial Conduction and Conduction Reliability

Contour: 0.7×20 mm

Thickness: 0.2 mm

Bump specification: gold-plating, height: 12 μm, size: 15×100 μm, distance between bumps: 15 μm, number of terminals: 1,300 (650 terminals on each long side of contour of IC)

### Glass Substrate

Glass material: glass available from Corning Incorporated

Contour: 30×50 mm

Thickness: 0.5 mm

Electrode: ITO wiring

### (b) Short Circuit Occurrence Ratio

In the connection product for evaluation obtained in (a), 200 spaces between the bumps were optionally extracted and observed by a metallographical microscope. From the observation, aggregation or linkage of the conductive particles linked between the adjacent bumps was confirmed. Thus, the short circuit occurrence ratio was determined. In evaluation of the short circuit occurrence ratio, the absence of aggregation or linkage was evaluated as OK, and the presence of one or more aggregations or linkages was evaluated as NG.

### (c) Conductive Particle Capturing Efficiency

In the connection product for evaluation obtained in (a) in each of Examples and Comparative Examples, the number of conductive particles captured by 100 bumps was measured. From the measurement, the conductive particle capturing efficiency was evaluated by a percentage of the area of the conductive particles captured per bump relative to the area of a terminal in accordance with the following criteria.

A: The sum total of area of the conductive particles captured was 8% or more relative to the area of the terminal.

B: The sum total of area of the conductive particles captured was 5% or more and less than 8% relative to the area of the terminal.

C: The sum total of area of the conductive particles captured was less than 5% relative to the area of the terminal.

TABLE 1

| | | Comparative | Comparative | Comparative | | | |
|---|---|---|---|---|---|---|---|
| | | Example 1 | Example 2 | Example 3 | Example 1 | Example 2 | Example 3 |
| Shape of Conductive | | Particle D | Particle A | Particle A | Particle A | Particle B | Particle C |
| Particles | Major Axis (μm) | 4 | 14 | 14 | 14 | 8 | 5.2 |
| | Minor Axis (μm) | 4 | 3.9 | 3.9 | 3.9 | 3.9 | 3.9 |
| | Aspect Ratio | 1 | 3.6 | 3.6 | 3.6 | 2.1 | 1.3 |
| Dispersion State of | Arrangement | FIG. 3A | None | FIG. 3A | FIG. 3A | FIG. 3A | FIG. 3A |
| Conductive Particles | | Tetragonal | | Tetragonal | Tetragonal | Tetragonal | Tetragonal |
| | | Lattice | | Lattice | Lattice | Lattice | Lattice |
| | Presence orAbsence of | None | Presence | None | None | None | None |
| | Contact Particles as | | | | | | |
| | Viewed in Plan View | | | | | | |
| | Inclination Angle θ (°) | — | ≦15 | >40 | ≦15 | ≦15 | ≦15 |
| | Number Density | 16600 | 3700 | 3700 | 3700 | 6400 | 9900 |
| | (particles/mm²) | | | | | | |
| | Area Occupancy Ratio | 20 | 20 | 15 | 20 | 20 | 20 |
| | (%) | | | | | | |
| Film | Thickness of Second | 3 | 5 | 3 | 3 | 3 | 3 |
| | Insulating Resin Layer | | | | | | |
| | (μm) | | | | | | |
| | Thickness of First | 15 | 13 | 15 | 15 | 15 | 15 |
| | Insulating Resin Layer | | | | | | |
| | (μm) | | | | | | |
| | Entire Thickness (μm) | 18 | 18 | 18 | 18 | 18 | 18 |
| Evaluation | Initial Conduction | OK | OK | NG | OK | OK | OK |
| | Short Circuit Occurrence | OK | NG | OK | OK | OK | OK |
| | Ratio | | | | | | |
| | Conductive Partide | C | C | C | A | A | B |
| | Capturing Efficiency | | | | | | |

TABLE 2

| | Examples 1 to 3 and Comparative |
|---|---|
| | Examples 1 to 3 |
| First Insulating Resin | |
| Phenoxy Resin (*1) | 30 |
| Epoxy Resin (*2) | 40 |
| Cationic Curing Agent (*3) | 2 |
| Second Insulating Resin | |
| Phenoxy Resin (*1) | 30 |
| Epoxy Resin (*2) | 40 |
| Cationic Curing Agent (*3) | 2 |
| Filler (*4) | 30 |

(*1) Nippon Steel & Sumikin Chemical Co., LTd., YP-50 (Thermoplastic Resin)
(*2) Mitsubishi Chemical Corporation, jER828 (Thermosetting Resin)
(*3) Sanshin Chemical Industry Co., Ltd., SI-60L (Latent Curing Agent)
(*4) Nippon Aerosil Co., Ltd., AEROSIL RX300

As seen from Table 1, in Examples 1 to 3 in which the aspect ratio was 1.3 or more and the conductive particles were arranged, all the initial conduction characteristics, the short circuit occurrence ratio, and the conductive particle capturing efficiency were good. In contrast, in Comparative Example 1, the conductive particle capturing efficiency was low since the conductive particles had a spherical shape. In Comparative Example 2, although the aspect ratio of the conductive particles was 1.3 or more, the conductive particles were randomly disposed and there were the conductive particles overlapped as viewed in a plan view. Therefore, the short circuit occurrence ratio was low. In Comparative Example 3, the inclination angle was excessively large, and therefore, the conductive particles were unlikely to be captured. Thus, the initial conduction characteristics were not good.

As Examples 4 to 6, the anisotropic conductive films obtained in Examples 1 to 3 were evaluated in the same manner as in Examples 1 to 3 except that the films were each bonded to the glass substrate so as to be inclined at an angle Φ of 80° formed between the longitudinal direction of the film and the major axis direction A of each of the conductive particles as shown in FIG. 2A. For the resulting evaluation results in Examples 4 to 6, all the initial conduction characteristics, the short circuit occurrence ratio, and the conductive particle capturing efficiency were all good similarly to Examples 1 to 3.

### Example 7

(Production of Anisotropic Conductive Film in which Columnar Conductive Glass Particles were Dispersed and Held in Single Layer Form)

40 parts by mass of a phenoxy resin (YP-50, Nippon Steel & Sumikin Chemical Co., Ltd.), 40 parts by mass of a liquid epoxy resin (jER828, Mitsubishi Chemical Corporation), 20 parts by mass of a microencapsulated latent curing agent (NOVACURE HX3941HP, Asahi Kasei Corporation), and 28 parts by mass of cylindrical conductive glass particles (PF-39SSSCA, Nippon Electric Glass Co., Ltd.) (average major axis length: 14 μm, average minor axis length: 3.9 μm) that had been plated with nickel (base) so as to have a thickness of 0.3 μm on a surface thereof and plated with gold (surface layer) so as to have a thickness of 0.1 μm on a surface of the base were mixed in toluene so that the solid content was 50% by mass. Thus, a mixed liquid was prepared. This mixed liquid was applied to a polyethylene terephthalate release film (PET release film) having a thickness of 50 μm so as to have a dried thickness of 20 μm, and dried in an oven at 80° C. for 5 minutes, to obtain a thermal polymerization-type anisotropic conductive film.

The dispersion state of the cylindrical conductive glass particles in this anisotropic conductive film was observed by an optical microscope. All the conductive particles were not in contact with each other as viewed in a plan view.

### Example 8

(Production of Anisotropic Conductive Film of Two-Layer Structure in which Second Adhesion Layer is Layered on First Adhesion Layer Containing Columnar Conductive Glass Particles)

### (Formation of First Adhesion Layer)

40 parts by mass of a phenoxy resin (YP-50, Nippon Steel & Sumikin Chemical Co., Ltd.), 40 parts by mass of a liquid epoxy resin (jER828, Mitsubishi Chemical Corporation), 20 parts by mass of a microencapsulated latent curing agent (NOVACURE HX3941HP, Asahi Kasei Corporation), and 14 parts by mass of cylindrical conductive glass particles (PF-39SSSCA, Nippon Electric Glass Co., Ltd.) (average major axis length: 14 μm, average minor axis length: 3.9 μm) that had been plated with nickel (base) so as to have a thickness of 0.3 μm on a surface thereof and plated with gold (surface layer) so as to have a thickness of 0.1 μm on a surface of the base were mixed in toluene so that the solid content was 50% by mass. Thus, a mixed liquid was prepared. This mixed liquid was applied to a polyethylene terephthalate release film (PET release film) having a thickness of 50 μm so as to have a dried thickness of 5 μm, and dried in an oven at 80° C. for 5 minutes, to form a first adhesion layer.

### (Formation of Second Adhesion Layer)

Next, 40 parts by mass of a phenoxy resin (YP-50, Nippon Steel & Sumikin Chemical Co., Ltd.), 40 parts by mass of a liquid epoxy resin (jER828, Mitsubishi Chemical Corporation), and 20 parts by mass of a microencapsulated latent curing agent (NOVACURE HX3941HP, Asahi Kasei Corporation) were mixed in toluene so that the solid content was 50% by mass. Thus, a mixed liquid was prepared. This mixed liquid was applied to a polyethylene terephthalate release film (PET release film) having a thickness of 50 μm so as to have a dried thickness of 15 μm, and dried in an oven at 80° C. for 5 minutes, to form a second adhesion layer that was comparatively thick.

### (Lamination of First and Second Adhesion Layers)

The thus obtained first adhesion layer and second adhesion layer that was comparatively thick were laminated under conditions of 60° C. and 0.5 MPa, to obtain an anisotropic conductive film.

The dispersion state of the cylindrical conductive glass particles in this anisotropic conductive film was observed by an optical microscope. All the conductive particles were not in contact with each other as viewed in a plan view.

### Comparative Example 4

(Production of Anisotropic Conductive Film in which Spherical Conductive Particles are Dispersed and Held in Single Layer Form)

A mixed liquid was prepared in the same manner as in Example 7 except that 28 parts by mass of the “cylindrical conductive glass particles” in Example 7 was changed to 12 parts by mass of conductive particles having an average particle diameter of 4 μm (Ni/Au plated resin particles, AUL704, Sekisui Chemical Co., Ltd.). A thermal polymerization-type anisotropic conductive film was produced using the mixed liquid.

### Comparative Example 5

(Production of Anisotropic Conductive Film in which Spherical Conductive Particles and Spherical Spacers are Dispersed and Held in Single Layer Form)

A thermal polymerization-type anisotropic conductive film was obtained by repeating Comparative Example 4 except that 15 parts by mass of spherical spacers having an average particle diameter of 1 μm (Si filler) was added to the mixed liquid in Comparative Example 4.

### Comparative Example 6

(Production of Anisotropic Conductive Film of Two-Layer Structure in which First Adhesion Layer Containing Spherical Spacers and Conductive Particles and Second Adhesion Layer were Layered)

A first adhesion layer was formed by repeating Example 8 except that 14 parts by mass of the “cylindrical conductive glass particles” in Example 8 was changed to 7.5 parts by mass of spherical spacers having an average particle diameter of 1 μm (Si filler) and 6 parts by mass of conductive particles having an average particle diameter of 4 μm (Ni/Au plated resin particles, AUL704, Sekisui Chemical Co., Ltd.). A second adhesion layer that was comparatively thick was formed and the first and second adhesion layers were laminated by repeating Example 8, to obtain a thermal polymerization-type anisotropic conductive film.

### <Evaluation>

For the anisotropic conductive films of Examples 7 and 8 and Comparative Examples 4, 5, and 6, the initial conduction resistance was tested and evaluated as follows. The obtained results are shown in Table 3.

### (Initial Conduction Resistance)

The anisotropic conductive film (1.5 mm in length×40 mm in width) of each of Examples and Comparative Examples was placed between a glass substrate for evaluation of initial conduction resistance value and a flexible printed circuit substrate (FPC substrate), and heated and pressurized (200° C., 5 MPa, 15 seconds) by a thermal pressing tool, to obtain a connection product for evaluation. The conduction resistance value of this connection product for evaluation was measured by a digital multimeter 7557 (Yokogawa Electric Corporation). The used glass substrate for evaluation and FPC substrate are as follows. For practical use, the conduction resistance is desirably 4Ω or less.

### “Glass Substrate for Evaluation of Initial Conduction Resistance Value”

Glass material: alkali glass (available from Corning Incorporated)

Contour: 30×50 mm

Thickness: 0.7 mm

Electrode: solid electrode of indium-tin composite oxide (ITO) with a thickness of 220 nm

### “FPC Substrate”

Film material: polyimide film with a thickness of 38 μm (Kapton type)

Film width of connection portion: 1.5 mm

Bump size: copper/nickel bump with a length of 2,500 μm, a width of 25 μm, and a height of 8 μm

Bump arrangement: 15 bumps (a bump at the left end is No. 1, and a bump at the right end is No. 15) were disposed in parallel at a pitch of 50 μm at a central region in a width direction of the film.

### “Thermal Pressing Tool Having Flat Pressing Surface”

Size of pressing surface: 100 mm×1.5 mm (the longitudinal direction was matched with the width direction of the FPC film)

Partial contact condition: The tool was inclined at 0.2° so that partial contact was caused on the right side thereof.

TABLE 3

| | Bump- | | | | | | |
|---|---|---|---|---|---|---|---|
| | Forming | Bump | Example | | Comparative Example | | |
| | Region | No. | 7 | 8 | 4 | 5 | 6 |
| Initial | Side where | 1 | 2.4 | 1.4 | 7.9 | 17.2 | 15.6 |
| Conduction | No Partial | 2 | 2.3 | 1.5 | 6.3 | 14.3 | 15.1 |
| Resistance | Contact is | 3 | 2.1 | 1.5 | 4.7 | 10.9 | 13.7 |
| Value [Ω] | Caused | 4 | 1.8 | 1.5 | 3.4 | 7.5 | 13.2 |
| | (Left) | 5 | 1.8 | 1.5 | 2.3 | 5.6 | 12.7 |
| | Central | 6 | 1.4 | 1.3 | 1.1 | 2.1 | 9.3 |
| | Region | 7 | 1.4 | 1.2 | 1.2 | 1.9 | 9.7 |
| | | 8 | 1.3 | 1.3 | 1.2 | 2 | 10.2 |
| | | 9 | 1.3 | 1.1 | 1.2 | 2 | 9.8 |
| | | 10 | 1.3 | 1.3 | 1.2 | 1.9 | 10.4 |
| | Side where | 11 | 1.3 | 1.3 | 1.1 | 1.8 | 9.7 |
| | Partial | 12 | 1.4 | 1.4 | 1.1 | 1.8 | 9.8 |
| | Contact is | 13 | 1.4 | 1.3 | 1.1 | 1.8 | 9.8 |
| | Caused | 14 | 1.3 | 1.3 | 1.1 | 1.8 | 9.6 |
| | (Right) | 15 | 1.4 | 1.3 | 1.2 | 1.8 | 9.5 |

At the central region of the FPC substrate, the bumps Nos. 6 to 10 to be considered to be pressed at a usual pressing force were formed. On the side where no partial contact was caused (left side), the bumps Nos. 1 to 5 to be considered to be pressed at a weaker pressing force than the usual pressing force due to partial contact were formed. On the side where partial contact was caused (right side), the bumps Nos. 11 to 15 to be considered to be pressed at a stronger pressing force than the usual pressing force due to partial contact were formed. It is considered that the pressing force is gradually increased from the bump No. 1 to the bump No. 15 over the whole.

As seen from Comparative Example 4 of Table 3, in the conventional anisotropic conductive film using no columnar conductive glass particles, the conduction resistance value especially on the side where no partial contact was caused was largely increased as the pressing force was decreased, and the conduction resistance values of the bumps Nos. 1 to 3 were more than 4Ω.

The anisotropic conductive film of Comparative Example 5 was an anisotropic conductive film in which the anisotropic conductive film of a single layer of Comparative Example 4 further contained the spherical spacers. The conduction resistance value on the side where no partial contact was caused was increased as the pressing force was decreased. The degree of the increase was larger than that in Comparative Example 4. The conduction resistance values of the bumps Nos. 1 to 5 were more than 4Ω, and in particular, the conduction resistance values of the bumps Nos. 1 to 3 were more than 10Ω.

The anisotropic conductive film of Comparative Example 6 was an anisotropic conductive film in which a thinner adhesion layer in a two-layer structure contained the spherical spacers and conductive particles. The conduction resistance value on the side where no partial contact was caused was increased as the pressing force was decreased. The conduction resistance values of the bumps Nos. 1 to 15 were more than 9Ω.

In the anisotropic conductive films of Examples 7 and 8, the conduction resistance value on the side where no partial contact was caused was slightly increased as the pressing force was decreased. The conduction resistance values in both the anisotropic conductive films were less than 4Ω. Therefore, sufficient conduction performance was obtained in both the anisotropic conductive films. In particular, the anisotropic conductive film of Example 8 had a two-layer structure having a thin adhesion layer and a thick adhesion layer, the thin adhesion layer contained columnar conductive glass particles, and the thick adhesion layer did not contain conductive particles. Therefore, partial contact tended to be favorable as compared with Example 7. In Examples 7 and 8, the columnar conductive glass particles were substantially parallel to the plane of the film. However, the conductive particles of Example 8 were parallel more than Example 7. The amount of the columnar conductive glass particles mixed in Example 8 was a half of that in Example 7. Even in this case, better characteristics for partial contact were obtained. Since the layer containing the columnar conductive glass particles was sufficiently thin as compared with the major axis of the columnar conductive glass particles, the columnar conductive glass particles were parallel to the plane of the film during applying more than Example 7. Therefore, it is considered that the effect is likely to be expressed.

### REFERENCE SIGNS LIST

1A, 1B, 1C, 1D, 1E anisotropic conductive film
1X conventional anisotropic conductive film
2, 2a, 2b conductive particle
3, 3a, 3b insulating adhesive layer or adhesion layer
4 second insulating resin layer
5 first insulating resin layer
10 terminal
100 flexible printed circuit (FPC) substrate
110 bump
115 thermal pressing tool
120 glass substrate
A major axis direction of conductive particle
L width of bump group of FPC substrate
L1 major axis length of conductive particle
L2 minor axis length of conductive particle
L3 closest distance between conductive particles as viewed in plan view
P arrangement axis of conductive particles
S film surface
θ angle formed between film surface and major axis direction of conductive particle

1. An anisotropic conductive film comprising an insulating adhesive layer containing conductive particles, wherein the conductive particles have an aspect ratio of 1.2 or more and are dispersed without being in contact with each other as viewed in a plan view, and an angle formed between a film surface of the anisotropic conductive film and a major axis direction of each of the conductive particles is less than 40°.

2. The anisotropic conductive film according to claim 1, wherein the conductive particles are columnar conductive glass particles having a conductive layer at at least a portion of a surface thereof.

3. The anisotropic conductive film according to claim 1, wherein the conductive particles have a cylindrical shape.

4. The anisotropic conductive film according to claim 1, wherein the conductive particles have an aspect ratio of 1.3 or more and 20 or less.

5. The anisotropic conductive film according to claim 1, wherein the conductive particles have an average major axis length of 4 μm or more and 60 μm or less.

6. The anisotropic conductive film according to claim 1, wherein a distance between an optional conductive particle and a conductive particle closest to the optional conductive particle as viewed in a plan view is 0.5 or more times a minor axis length of the conductive particle.

7. The anisotropic conductive film according to claim 1, wherein an optional conductive particle and a conductive particle closest to the optional conductive particle are not overlapped in a longitudinal direction of the anisotropic conductive film.

8. The anisotropic conductive film according to claim 1, wherein an angle formed between a film surface of the anisotropic conductive film and the major axis direction of the conductive particle is within 15°.

9. The anisotropic conductive film according to claim 8, wherein the film surface of the anisotropic conductive film and the major axis direction of the conductive particle are substantially parallel to each other.

10. The anisotropic conductive film according to claim 1 wherein the major axis directions of the conductive particles are set in parallel to, or in a direction oblique to, a longitudinal direction of the anisotropic conductive film as viewed in a plan view.

11. The anisotropic conductive film according to claim 1 wherein the conductive particles are regularly arranged as viewed in a plan view.

12. The anisotropic conductive film according to claim 11, wherein the conductive particles are arranged in a lattice shape as viewed in a plan view.

13. The anisotropic conductive film according to claim 12, wherein in the conductive particles on an arrangement axis in a film short-side direction, a circumscribed line of an optional conductive particle in the film short-side direction is matched with a circumscribed line of a conductive particle adjacent to the optional conductive particle in the film short-side direction.

14. The anisotropic conductive film according to claim 11, wherein in the conductive particles on an arrangement axis in a film short-side direction, a circumscribed line of an optional conductive particle in the film short-side direction penetrates a conductive particle adjacent to the optional conductive particle.

15. The anisotropic conductive film according to claim 1, having a two-layer structure including an adhesion layer having the insulating adhesive layer containing the conductive particles and an adhesion layer having an insulating adhesive layer containing an insulating spacer.

16. A connection structure wherein a connecting terminal of a first electronic component and a connecting terminal of a second electronic component are connected by anisotropic conductive connection using the anisotropic conductive film according to claim 1.

17. A method for connecting a first electronic component to a second electronic component by anisotropic conductive connection using the anisotropic conductive film according to claim 1, the method comprising:
temporarily bonding the anisotropic conductive film to the second electronic component;
mounting the first electronic component on the anisotropic conductive film having been temporarily bonded; and
thermo-compression bonding them from a side of the first electronic component.
